(19) United States
(12) Patent Application Publication
(10) Pub. No.: US 2019/0161205 A1
(43) Pub. Date: May 30, 2019

(54) LIGHTNING DIVERTER SYSTEM FOR AIRCRAFT RADOME

(71) Applicant: Airbus Operations SAS, Toulouse (FR)

(72) Inventors: Jean-Claude MARTY, TOULOUSE (FR); Christophe BERNUS, TOULOUSE (FR)

(21) Appl. No.: 16/202,804

(22) Filed: Nov. 28, 2018

(30) Foreign Application Priority Data
Nov. 28, 2017 (FR) 1761261

(51) Int. Cl. B64D 45/02; H01Q 1/42; H01Q 1/28; B64C 1/36

(52) U.S. Cl. CPC B64D 45/02; B64C 1/36; H01Q 1/286; H01Q 1/42

(57) ABSTRACT

A lightning diverter system configured to equip a radome of an aircraft comprises a segmented strip configured to transmit lightning by ionization of the air to a point of junction with the aircraft structure. The segmented strip is configured to be installed on an inner wall of the radome. The lightning diverter system comprises at least one metal block configured to be installed in a through-hole of the radome, so as to be flush with an outer wall of the radome opposite to the inner wall and which is configured to be subject to an airflow when the aircraft is moving. The arrangement of the segmented strip and of the metal block or blocks is such that, when the lightning strikes the metal block on the outer wall of the radome, the lightning is transmitted to the segmented strip on the inner wall of the radome.

### CROSS-REFERENCES TO RELATED APPLICATIONS

This application claims the benefit of the French patent application No. 1761261 filed on Nov. 28, 2017, the entire disclosures of which are incorporated herein by way of reference.

### BACKGROUND OF THE INVENTION

The present invention relates to a lightning diverter system for an aircraft radome, an aircraft radome equipped with such a lightning diverter system, and an aircraft equipped with at least one such radome.

The lightning diverter systems for aircraft are typically composed of continuous metal strips which are installed on the outer wall of a radome of the aircraft and linked electrically to a junction with the fuselage of the aircraft. The presence of such continuous metal strips thus installed on the radome concerned does, however, generate aerodynamic disturbances (laminar-turbulent transitions) which increase the aerodynamic drag and therefore the fuel consumption of the aircraft. Another effect of such lighting diverter systems is a disturbance of the radiation pattern of the antenna system or systems that the radome protects, and a lowering of the transparency to the radiofrequency waves. In order to improve aerodynamics, it has been proposed in the patent documents FR 2924686 B1 and FR 2999535 B1, to install these continuous metal strips on the inner wall of the radome. The difficulties linked to the disturbances of the radiation pattern of the antenna system or systems that the radome protects and to the lowering of transparency to the radiofrequency waves do, however, remain.

So as to limit the disturbance of the antenna system or systems that the radome protects, segmented strip lightning diverter systems (or “segmented diverter strips”) have emerged. Their principle is to channel the path of the lightning by ionization of the air between the segments when the surrounding electrical field becomes significant, which is the case in the presence of storm clouds. Given that the size of the segments (typically from 1 to 3 mm) is small with respect to the wavelength of the radar antenna systems (typically with a frequency of 9 GHz, or a wavelength of 32 mm) and the wavelength of the communication antenna systems (typically with a frequency of 300 MHz, or a wavelength of 1 m), these segmented strips have almost no impact on the radiation pattern of these antenna systems and on the transparency of the radome to the radiofrequency waves.

These segmented strip lightning diverter systems are however sensitive to water and to ice, since, in these conditions, the ionization of the air is made difficult. Thus, the presence of water (which is commonplace in stormy conditions) or of ice, the segmented strip lightning diverter systems lose effectiveness.

It is desirable to provide a lightning diverter system solution which makes it possible to limit both the disturbance of the antenna system or systems protected by the radome and the aerodynamic drag and therefore the fuel consumption of the aircraft, as well as the sensitivity to water or to ice.

### SUMMARY OF THE INVENTION

One object of the present invention is to propose a lightning diverter system configured to equip a radome of an aircraft and comprising a segmented strip or a succession of segmented strips which is configured to transmit the lightning, by ionization of the air between evenly spaced segments on the segmented strip, to a point of junction with the structure of the aircraft. The lightning diverter system is such that the segmented strip is installed on the side of an inner wall of the radome; the lightning diverter system also comprises at least one metal block configured to be installed in a through-hole of the radome so as to be flush with an outer wall of the radome which is opposite to the inner wall and which is configured to be subject to an airflow when the aircraft is moving. Furthermore, the arrangement of the segmented strip and of the metal block or blocks is such that, when the lightning strikes on the metal block on the side of the outer wall of the radome, the lightning is transmitted to the segmented strip on the side of the inner wall of the radome.

Thus, one or more antenna systems protected by the radome are not disturbed by the duly constituted lightning diverter system by virtue of the use of segmented strips, and the aerodynamic drag is reduced, as is the fuel consumption of the aircraft, by virtue of the flush arrangement of each metal block with the outer wall of the radome. The use of segmented strips makes it possible to not compromise the transparency of the radome to the radiofrequency waves. Finally, the positioning of the segmented strips on the side of the inner wall of the radome protects them from bad weather, in particular from rain and from ice. The segmented strips are thus more effective and facilitate painting and/or sanding operations which could take place on the outer wall of the radome.

According to a particular embodiment, the segmented strip is configured to be glued onto the inner wall of the radome.

According to a particular embodiment, each metal block has a tapered form and is configured to be installed such that the wider base of this tapered form is flush with the outer wall of the radome.

According to a particular embodiment, the lightning diverter system also comprises a continuous metal strip or a succession of continuous metal strips configured to be placed on the side of the inner wall and configured to connect the segmented strip to the junction point.

According to a particular embodiment, the continuous metal strip or the succession of continuous metal strips is configured to be held on the side of the inner wall by virtue of the at least one metal block.

According to a particular embodiment, the segmented strip forms part of a succession of segmented strips, between which are inserted the metal blocks.

Another object of the present invention is to propose a radome configured to equip an aircraft, the radome comprising an outer wall configured to be subject to an airflow when the aircraft is moving and an inner wall opposite to the outer wall and comprising at least one lightning diverter system in any one of the embodiments represented above.

Another object of the present invention is to propose an aircraft comprising at least one antenna system and at least one radome as presented above, each radome protecting at least one the antenna system.

According to a particular embodiment, the aircraft is configured such that the antenna system is placed at a distance in the air from the closest metal block that is greater than the aggregate air distance between the segments of the segmented strip or strips.

### BRIEF DESCRIPTION OF THE DRAWINGS

The features of the invention mentioned above, and others, will become more clearly apparent on reading the following description of at least one exemplary embodiment, the description being given in relation to the attached drawings, in which:

FIG. 1 schematically illustrates, in a side view, an aircraft in which the present invention can be implemented;

FIG. 2 schematically illustrates, in a plan view, a segmented strip used in a lightning diverter system of the aircraft;

FIG. 3 schematically illustrates a simplified cross-sectional view of an assembly of the segmented strip on a radome panel of the aircraft;

FIG. 4 schematically illustrates, in perspective, an airflow over an outer wall of the radome panel on which the assembly of FIG. 3 is produced;

FIG. 5 schematically illustrates, in a simplified cross-sectional view, a lightning diverter system arrangement combining internal segmented strips and internal continuous metal strips.

### DETAILED DESCRIPTION OF THE PREFERRED EMBODIMENTS

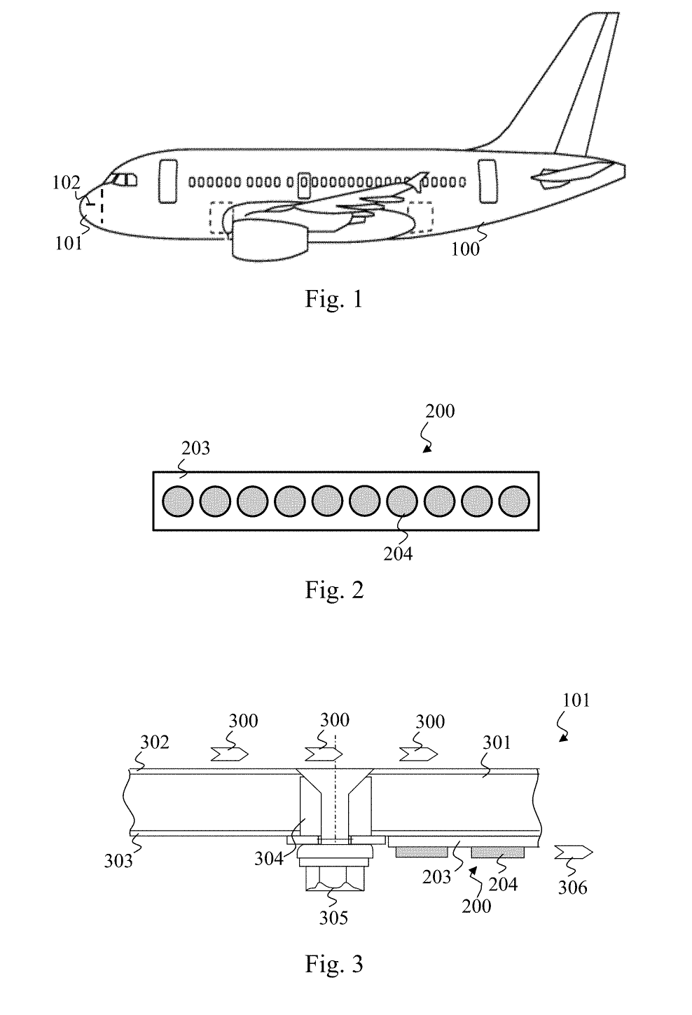

FIG. 1 schematically illustrates, in a side view, an aircraft 100 in which the present invention can be implemented. The aircraft 100 comprises one or more radomes 101. It will be considered hereinbelow, for purely illustrated purposes, that the aircraft 100 comprises a single radome 101, such as a nose radome configured to provide protection from bad weather for an antenna system 102, such as a radar antenna and/or a communication antenna. The radome 101 is equipped with a lightning diverter system, as described hereinbelow.

FIG. 2 schematically illustrates, in a plan view, a segmented strip 200 used in the lightning diverter system described hereinbelow. The segmented strip 200 comprises a set of metal pads 204 (or, generally, of metal segments) evenly spaced apart and on a sheet or a tape of dielectric material 203. The segmented strip 200 represented in FIG. 2 is configured to be glued onto a radome panel, according to an arrangement detailed hereinbelow in relation to FIG. 3.

FIG. 3 schematically illustrates a simplified cross-sectional view (shadings omitted) of an assembly of the segmented strip 200 on a panel forming the radome 101. The radome panel 101 comprises a core 301, for example made of cellular material or of foam, of which a first face is covered by a first skin 302 to form an outer wall of the radome 101 and a second face, opposite to the first face, is covered by a second skin 303 to form an inner wall of the radome 101. The first 302 and second 303 skins are made of dielectric material, for example composite material. As an illustration, the first 302 and second 303 skins are made of glass composite, or of silica composite, or of silicon carbide composite, or of quartz composite, or of basalt composite, or of aramid fibers, or of a hybrid composite.

The segmented strip 200 is mounted on the panel of the radome 101, so as to be installed inside the radome 101. This is thus called the inner segmented strip.

One or more metal blocks 305 make it possible to secure the lightning and transmit it to the segmented strip 200 or to a succession of segmented strips 200 inside the radome 101. Each metal block 305 is, for example, made of copper, or of stainless steel or of aluminum, or of titanium.

A single metal block 305 is represented by way of illustration in FIG. 3. Each metal block 305 serves as a lightning securing element. Each metal block 305 is installed in a hole through the panel of the radome 101, so as to be able to transmit the lightning from the outside of the radome 101 to the interior of the radome 101 where the segmented strip 200 or the succession of segmented strips 200 is situated. Each metal block 305 is installed so as to be flush with the outer wall of the radome 101, that is to say, that a base of the metal block 305 is at the same level as the surface of the outer wall of the radome 101, which is configured to be subject to an airflow (represented by arrows 300) when the aircraft 100 is moving.

In a particular embodiment, each metal block 305 has a tapered form, such that the wider base of this tapered form is flush with the outer wall or first skin 302 of the radome 101. In this case, each metal block 305 is installed such that the tapered form presses against a chamfer produced on the outer wall of the radome 101. The metal block 305 is then held in place using a nut, possibly complemented by a washer, and a threaded rod formed on a cylinder located in the extension of the narrower base of the tapered form of the metal block 305.

Other metal block 305 forms and assemblies are possible. For example, each metal block 305 can be installed through the radome panel 101 and held in position using glue. For example, each metal block 305 has a cylindrical form.

Each metal block 305 is mounted such that a metal end of the metal block 305 protrudes on the inner wall of the radome 101, so as to be able to transmit the lightning to the segmented strip 200 or to the succession of segmented strips 200. The installation of the segmented strip 200 or of the succession of segmented strips 200 is done in such a way as to have the last segment as close as possible to each metal block 305, typically at a distance similar to the distance that exists between the segments on the segmented strip 200. Preferentially, the distance separating each metal block 305 from the adjacent segment or segments is equal to the distance that exists between the segments.

Each metal block 305 is preferentially of a single piece.

Since the segmented strip 200 is then located inside the radome 101, the segmented strip 200 is not subject to climatic factors, such as rain, ice or dust. The segmented strip 200 is thus preserved from fouling, from wear and from erosion. The effectiveness of the segmented strip 200 is thus optimal and guaranteed. Moreover, since the segmented strip 200 is inside the radome 101, operations of painting and/or sanding of the radome 101 are facilitated, by avoiding the use of covers to protect the segmented strip 200 during the painting and/or sanding operations.

The segmented strip 200 is preferentially glued onto the inner wall of the radome 101. Other assemblies are possible for placing the segmented strip 200 on the inner wall of the radome 101, provided that, when the lightning strikes the metal block 305 on the side of the outer wall of the radome 101, the lightning is transmitted to the segments (e.g., pads) of the segmented strip 200 via the metal block 305. For example, the metal blocks 305 can be used as fixing means. According to an exemplary embodiment, each of the two ends of the segmented strip 200 comprises a void in the dielectric material allowing the passage of one metal block 305. The assembly of the segmented strip 200 is then done by means of the abovementioned nut and threaded rod. The threaded rod is then passed inside the corresponding void of the segmented strip 200 and the nut makes it possible, by tightening, to hold the segmented strip 200 in place on the side of the inner wall of the radome 101.

The assembly formed by the metal block 305 and the segmented strip 200 thus allows for a discharging (represented by an arrow 306) of the lightning by ionization of the air, as if the segmented strip 200 were placed on the outer wall of the radome 101. The lightning is discharged to the structure of the aircraft 100, on which the radome 101 is mounted. To do this, the segmented strip 200 or a succession of such segmented strips 200 is connected to the structure of the aircraft 100, possibly via a continuous metal strip 500 or a succession of such continuous metal strips 500, as is described hereinbelow in relation to FIG. 5.

The securing of each metal block 305 with the panel of the radome 101 can be reinforced using the resin 304 or an insulating spacer or an insulating insert.

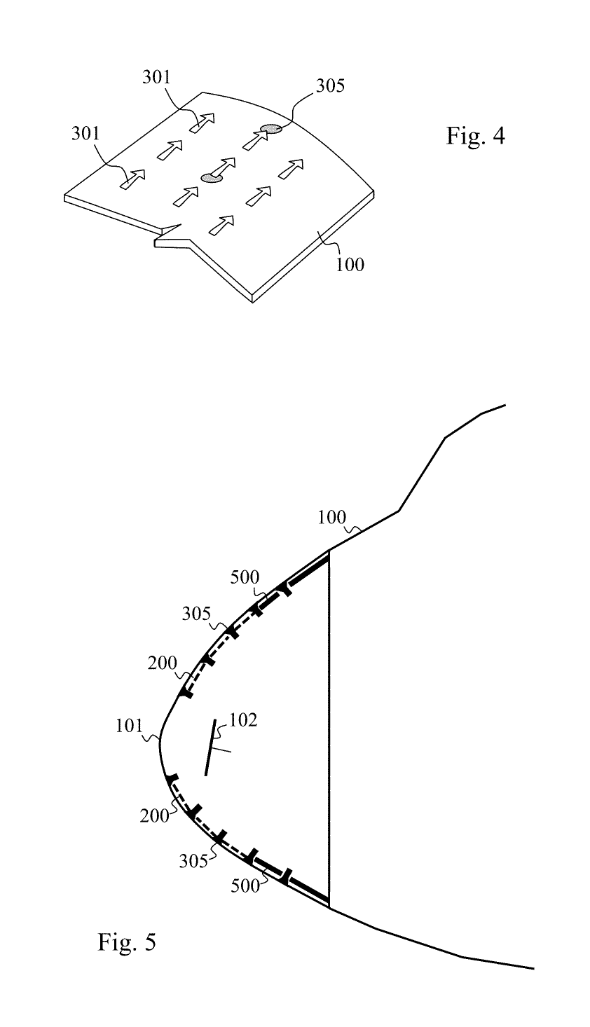

By virtue of the flush arrangement of each metal block 305 with the outer wall of the radome 101, the airflow (represented by arrows 300) takes place along a substantially smooth wall and therefore remains substantially laminar, as represented, in perspective, in FIG. 4. Thus, the aerodynamic drag is reduced, as is the fuel consumption of the aircraft 100.

FIG. 5 schematically illustrates, in a simplified cross-sectional view, a lightning diverter system arrangement combining internal segmented strips and internal continuous metal strips, in a particular embodiment of the invention.

An arrangement with a series of metal blocks 305 assembled on the radome 101 is produced as described above in relation to FIG. 3. The metal blocks 305 are linked on the inner wall of the radome 101, by a segmented strip 200 or by a succession of segmented strips 200. When a succession of segmented strips 200 is put in place, the metal blocks 305 are inserted between the segmented strips 200.

The connection of this segmented strip 200 or of this succession of segmented strips 200 to the point of junction (not represented in FIG. 5) on the structure of the aircraft 100 is produced by placing the segment closest to the junction point at a distance similar to the distance that exists between the segments of each segmented strip 200. Preferentially, the distance separating the junction point and this closest segment is equal to the distance that exists between the segments.

The connection of this segmented strip 200 or of this succession of segmented strips 200 to the point of junction (not represented in FIG. 5) on the structure of the aircraft 100 can be produced using a continuous metal strip 500 or a succession of continuous metal strips 500, so as to ensure a grounding. One or more metal blocks 305 can be used to assemble the continuous metal strip 500 or the succession of continuous metal strips 500 on the inner wall of the radome 101. An example of assembly between continuous metal strips 500 and metal blocks 305 is disclosed in the patent document FR 2999535 B1. More particularly, fixing blocks (such as the metal blocks 305) are inserted into through-holes produced in the panel of the radome 101, and are in electrical contact with the continuous metal strips 500, such that the continuous metal strips 500 are mounted offset relative to the central axes of the fixing blocks (i.e., axes coinciding with the drilling axes of the holes in the panel of the radome 101). “Mounted offset relative to the central axes of the fixing blocks,” should, in particular, be understood to mean that the longitudinal axis of each continuous metal strip 500 is not inscribed in the plane defined by the central axes of at least two fixing blocks. In particular, the longitudinal axis of each continuous metal strip 500 and the central axes of the fixing blocks do not intersect. Intermediate elements for the mounting of the continuous metal strips 500 can be used. Each intermediate element can comprise a body-forming part for the fixing thereof to a fixing block and, by protruding laterally from the body-forming part, a clamp-forming part for the fixing of a continuous metal strip 500. Each intermediate element can comprise two intermediate parts (or intermediate flanges), superposed relative to one another. Each intermediate part can comprise a first branch provided with an orifice, in particular substantially circular, for passage for a fixing block, the first two branches thus defining the body-forming part of the intermediate element. Each intermediate part can also comprise a second branch comprising an indent, in particular substantially hemicylindrical, the two second branches defining the clamp-forming part of the intermediate element. The two indentations thus define a through passage, in particular cylindrical for “sandwiching” the continuous metal strip 500 between the two indentations.

This arrangement is particularly advantageous for ensuring that the distance in the air between the antenna system 102 and the metal block 305 closest to the antenna system 102 is greater than the aggregate air distance between the segments (e.g., pads) of the segmented strip 200 or of the succession of segmented strips 200, which avoids a formation of an electrical arc between the metal block 305 and the antenna system 102.

As illustrated in FIG. 5, the arrangement described above can be replicated several times on the radome 101, substantially evenly distributed around the central axis of the radome 101, such that the segmented strips 200 extend the continuous metal strips 500 towards the central axis, on which the antenna system 102 is substantially located.

By virtue of this arrangement based on segmented strips 200, the radiation pattern of the antenna system 102 is not disturbed by the lightning diverter system, which itself is protected from bad weather by the radome 101 in the same way as the antenna system 102, and the transparency of the radome 101 to radiofrequency waves is not compromised.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A lightning diverter system configured to equip a radome of an aircraft and comprising:
a segmented strip configured to transmit lightning, by ionization of air between evenly spaced segments on said segmented strip, to a junction point with a structure of the aircraft,
the segmented strip being configured to be installed on a side of an inner wall of said radome;
at least one metal block configured to be installed in a through-hole of said radome so as to be flush with an outer wall of the radome opposite to said inner wall, the at least one metal block being configured to be subject to an airflow when the aircraft is moving,
the arrangement of the segmented strip and of the at least one metal block being such that, when lightning strikes said metal block on a side of the outer wall of the radome, the lightning is transmitted to said segmented strip on the side of the inner wall of the radome.

2. The lightning diverter system according to claim 1, wherein the segmented strip is configured to be glued onto the inner wall of the radome.

3. The lightning diverter system according to claim 1, wherein each metal block has a tapered form and is configured to be installed such that a wider base of the tapered form is flush with the outer wall of the radome.

4. The lightning diverter system according to claim 1, further comprising a continuous metal strip or a succession of continuous metal strips configured to be placed on the side of the inner wall and configured to connect the segmented strip to said junction point.

5. The lightning diverter system according to claim 4, wherein the continuous metal strip or the succession of continuous metal strips is configured to be held on the side of the inner wall by virtue of the at least one metal block.

6. The lightning diverter system according to claim 1, wherein said segmented strip forms part of a succession of segmented strips, between which are inserted said at least one metal block.

7. A radome configured to equip an aircraft, comprising:
an outer wall configured to be subject to an airflow when the aircraft is moving and an inner wall opposite to said outer wall and comprising at least one lightning diverter system according to claim 1.

8. An aircraft comprising at least one antenna system and at least one radome according to claim 7, each radome protecting at least one of said at least one antenna system.

9. The aircraft according to claim 8, wherein the antenna system is placed at a distance in air from a closest metal block that is greater than an aggregate air distance between all of the segments of the segmented strip.

10. The aircraft according to claim 8, wherein said segmented strip forms part of a succession of segmented strips, between which are inserted said at least one metal block, and wherein the antenna system is placed at a distance in air from a closest metal block that is greater than an aggregate air distance between all of the segments of the succession of segmented strips.
